(19) United States
(12) Patent Application Publication
(10) Pub. No.: US 2026/0218771 A1
(43) Pub. Date: Jul. 30, 2026

(54) DAMPING VALVE AND SHOCK ABSORBER

(71) Applicant: KYB Corporation, Tokyo (JP)

(72) Inventor: Takeshi YASUI, Tokyo (JP)

(73) Assignee: KYB Corporation, Tokyo (JP)

(21) Appl. No.: 19/146,808

(22) PCT Filed: Apr. 1, 2024
(86) PCT No.: PCT/JP2024/013442

§ 371 Date: Jul. 9, 2025

(30) Foreign Application Priority Data
Apr. 21, 2023 (JP) 2023-070070

(51) Int. Cl. F16F 9/348; F16F 9/19; F16F 9/516; F16K 31/363

(52) U.S. Cl. CPC F16F 9/348; F16K 31/363; F16F 9/19; F16F 9/516; F16F 2222/12; F16F 2228/066; F16F 2232/08; F16F 2234/02

(57) ABSTRACT

A damping valve (V) of the present invention includes: a valve seat member (3) including a port (3a) and a valve seat (3c) surrounding an opening downstream of the port (3a); a movable body (10) movable in a direction toward and away from the valve seat (3c); a facing member (9) facing the movable body (10) while being immovable with respect to the valve seat member (3); a contact body (12) provided to be displaceable toward the movable body (10) with respect to the facing member (9) to come into contact with the movable body (10); and a pilot passage (P) causing pressure upstream of the port (3a) to act on the contact body (12) so as to press the contact body (12) against the movable body (10).

### TECHNICAL FIELD

The present invention relates to a damping valve and a shock absorber.

### BACKGROUND ART

For example, as disclosed in JP 2003-123348 A, a damping valve used in a shock absorber interposed between a vehicle body and a wheel includes: a piston having a port; an annular leaf valve overlapping an end on a compression side chamber side of the piston so that an inner circumference of the leaf valve is fixed, while an outer circumference of the leaf valve is allowed to be deflected to open and close the port; a piston nut screwed to an outer circumference at a distal end of a piston rod to fix the piston to the piston rod, and having an annular fixed spring seat on an outer circumference thereof; an annular movable spring seat slidably placed on the outer circumference of the piston nut to be movable in an axial direction with respect to the piston nut, abutting against a surface on a piston-opposite side of the leaf valve, and facing the fixed spring seat in the axial direction; and a coil spring interposed between the fixed spring seat and the movable spring seat.

In the damping valve configured in this manner, the leaf valve is pressed against the piston by the biasing force of the coil spring. Therefore, when the extension speed of the shock absorber is low, the leaf valve remains seated without being deflected by the biasing force of the coil spring. On the other hand, when the extension speed of the shock absorber increases, the coil spring contracts the leaf valve opens the port at once, thereby realizing a saturation characteristic in which the damping force reaches a peak.

### CITATION LIST

### Patent Literature

Patent Literature 1: JP 2008-128348 A

### SUMMARY OF INVENTION

### Technical Problem

In the conventional damping valve described above, while the saturation characteristic can be realized as described above, damping force characteristics (characteristics of damping forces generated by the shock absorber with respect to the expansion/contraction speed of the shock absorber) are adjusted by setting the spring constant of the coil spring and the initial load that the coil spring applies to the leaf valve when the value is closed. The damping force characteristic after the leaf valve is opened can be adjusted by adjusting the spring constant of the coil spring, and the valve opening pressure of the leaf valve can be mainly adjusted by adjusting the initial load that the coil spring applies to the leaf valve.

In this manner, in the conventional damping valve, the damping force characteristics can be adjusted by the two adjustment elements, the spring constant of the coil spring and the initial load. However, in a case where it is desired to adjust the damping force characteristics according to the pressure upstream of the leaf valve, it is difficult to obtain desired damping force characteristics with the adjustment of the spring constant of the coil spring and the initial load only.

Therefore, an object of the present invention is to provide a damping valve capable of adjusting damping force characteristics depending on pressure upstream of a port and a shock absorber capable of improving ride comfort in a vehicle.

### Solution to Problem

In order to achieve the foregoing object, the damping valve of the present invention includes: a valve seat member including a port and a valve seat surrounding the port; a movable body movable in a direction toward and away from the valve seat; a facing member facing the movable body while being immovable with respect to the valve seat member; a contact body provided to be displaceable toward the movable body with respect to the facing member to come into contact with the movable body; and a pilot passage causing pressure upstream of the port to act on the contact body so as to press the contact body against the movable body.

According to the damping valve configured in this manner, the force with which the contact body is pressed against the movable body increases, thereby increasing the force that restrains the movable body from moving in a direction away from the valve seat member, and increasing the valve opening pressure for opening the port.

Further, the shock absorber includes a shock absorber main body including an outer shell and a piston rod inserted into the outer shell to be movable in an axial direction so that at least two operation chambers are provided inside the outer shell, and a damping valve provided between the operation chambers. In the shock absorber configured in this manner, damping force characteristics can be adjusted depending on pressure upstream of the port, thereby improving ride comfort in the vehicle.

### Advantageous Effects of Invention

Therefore, according to the damping valve of the present invention, it is possible to adjust damping force characteristics depending on pressure upstream of the port, and according to the shock absorber of the present invention, it is possible to improve ride comfort in the vehicle.

### BRIEF DESCRIPTION OF DRAWINGS

FIG. 1 is a longitudinal sectional view of a shock absorber including a damping valve according to an embodiment of the present invention.

FIG. 2 is an enlarged longitudinal sectional view of the damping valve according to the embodiment of the present invention.

FIG. 3 is an enlarged longitudinal sectional view of a damping valve according to a first modification of the embodiment of the present invention.

FIG. 4 is an enlarged longitudinal sectional view of a damping valve according to a second modification of the embodiment of the present invention.

### DESCRIPTION OF EMBODIMENTS

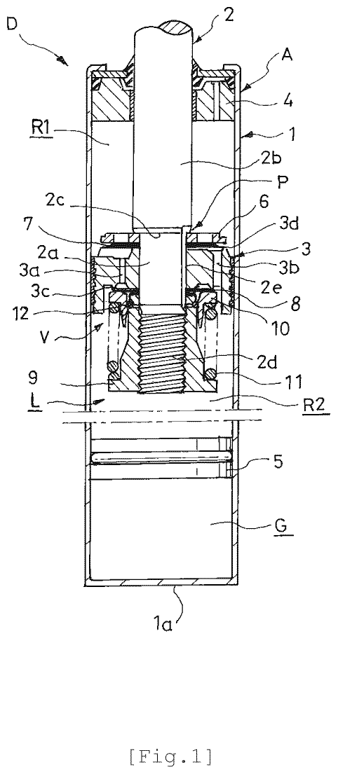

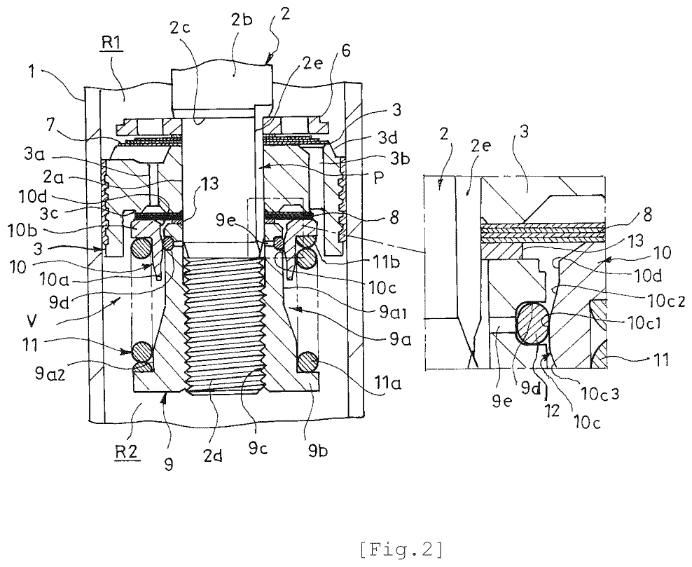

Hereinafter, the present invention will be described based on an embodiment illustrated in the drawings. As illustrated in FIGS. 1 and 2, a shock absorber D according to an embodiment includes a shock absorber main body A including a cylinder 1 serving as an outer shell and a piston rod 2 movably inserted into the cylinder 1 to be extendable and contractible, and a damping valve V provided between an extension side chamber R1 and a compression side chamber R2 as two operation chambers provided in the shock absorber main body A. This shock absorber D is interposed between a vehicle body and a wheel in a vehicle (not illustrated) for use to suppress vibration of the vehicle body and the wheel.

Hereinafter, each part of the shock absorber D will be described in detail. As illustrated in FIG. 1, the shock absorber main body A includes a bottomed cylindrical cylinder 1 serving as an outer shell, a piston rod 2 movably inserted into the cylinder 1, and a piston 3 connected to the piston rod 2, movably inserted into the cylinder 1, and partitioning the inside of the cylinder 1 into an extension side chamber R1 and a compression side chamber R2 serving as operation chambers.

A bracket (not illustrated) is provided at a proximal end, which is an upper end in FIG. 1, of the piston rod 2, and the piston rod 2 is connected to either the vehicle body or the wheel via the non-illustrated bracket. A bracket (not illustrated) is also provided at a bottom portion 1a of the cylinder 1, and the cylinder 1 is connected to the other of the vehicle body and the wheel via the non-illustrated bracket.

In this manner, the shock absorber P is interposed between the vehicle body and the wheel. Then, when the vehicle travels on an uneven road surface or the like and the wheels vibrate up and down with respect to the vehicle body, the piston rod 2 moves in and out of the cylinder 1, the shock absorber D extends and contracts, and the piston 3 moves up and down (in the axial direction) in the cylinder 1.

In addition, the shock absorber main body A includes an annular rod guide 4 that closes an upper end of the cylinder 1 and allows the piston rod 2 to be slidably inserted thereinto on its inner circumference. Therefore, the inside of the cylinder 1 is a sealed space. A free piston 5 is slidably inserted into the cylinder 1 on a side opposite to the piston rod 2 as viewed from the piston 3 in the cylinder 2.

A liquid chamber L is formed on an upper side of the free piston 5, and a gas chamber G is formed on a lower side of the free piston 5 in the cylinder 1. Furthermore, the liquid chamber L is partitioned by the piston 3 into an extension side chamber R1 on the piston rod 2 side and a compression side chamber R2 on the piston 3 side, and each of the extension side chamber R1 and the compression side chamber R2 is filled with liquid. The liquid filled in the shock absorber main body A may be hydraulic oil, water, an aqueous solution, another type of liquid, or the like. On the other hand, air or gas such as nitrogen gas is enclosed in the gas chamber G in a compressed state.

When the piston rod 2 is retracted from the cylinder 1 during the extension operation of the shock absorber u, and the cylinder capacity increases to an extent corresponding to a volume of the piston rod 2 retracted from the cylinder 1, the free piston 5 moves upward in the cylinder 1 to enlarge the gas chamber G. On the contrary, when the piston rod 2 enters the cylinder 2 during the contraction operation of the shock absorber D and the cylinder capacity decreases to an extent corresponding to a volume of the piston rod 2 entering the cylinder 1, the free piston 5 moves downward in the cylinder 1 to reduce the gas chamber G.

Note that, instead of the free piston 5, a bladder, a bellows, or the like may be used to separate the liquid chamber L and the gas chamber G from each other, and the configuration of the movable partition wall serving as a partition can be appropriately changed.

Furthermore, in the present embodiment, the shock absorber D is a single-piston rod, monotube shock absorber, and the gas chamber G is enlarged or reduced by the free piston 5 when the shock absorber D extends or contracts to compensate for the volume of the piston rod 2 moving in and out of the cylinder 1. However, the configuration for the volume compensation can also be appropriately changed.

For example, in a case where the shock absorber is a double-cylinder shock absorber by eliminating the free piston 5 and the gas chamber G and providing an outer shell on the outer circumference of the cylinder 1, and forming a reservoir for storing the liquid between the cylinder 1 and the outer shell, and the volume of the piston rod 2 roving in and out of the cylinder 1 may be compensated for by the reservoir. Note that the reservoir may be formed in a tank separated from the cylinder 1. Tn addition, the shock absorber D may be configured as a double piston rod type shock absorber in which the piston 3 is placed at the center of the piston rod 2 and the end portions of the piston rod 2 protrude to the outside of the cylinder 1 from both ends of the cylinder 1.

The piston rod 2 has a columnar shape, with a reduced outer diameter on a distal end side, and includes a small-diameter portion 2a having the smallest diameter on the distal end side, a large-diameter portion 2b having a larger outer diameter than the small-diameter portion 2a and provided on an upper side in FIG. 2 of the small-diameter portion 2a, a step portion 2c provided at a boundary between the small-diameter portion 2a and the large-diameter portion 2b, and a screw portion 2d provided on an outer circumference at a distal end of the small-diameter portion 2a.

Next, in the present embodiment, the damping valve V is provided in a piston portion of the shock absorber D using the piston 3 placed on the piston rod as a valve seat member. Specifically, the damping valve V includes a piston 3 serving as a valve seat member having an extension side port 3a serving as a port and an extension side valve seat 3c serving as a valve seat surrounding the extension side port 3a, a movable body 10 movable in a direction toward and away from the piston 3, a piston nut 9 serving as a facing member facing the movable body 10 while being immovable with respect to the piston 3, a contact body 12 provided to be displaceable toward the movable body 10 with respect to the piston nut 9 and in contact with the movable body 10, and a pilot passage P provided in the piston nut 9 to apply upstream pressure of the extension side port 3a to the contact body 12 so as to press the contact body 12 against the movable body 10.

Hereinafter, the damping valve V and each member placed on the small-diameter portion 2a of the piston rod 2 will be described in detail. A valve stopper 6, a compression side leaf valve 7, a piston 3 serving as a valve seat member, an extension side leaf valve 8 serving as a valve body, a piston nut 9 in which the contact body 12 is placed, a movable body 10, and a coil spring 11 serving as a spring member are assembled to the small-diameter portion a of the piston rod 2. The valve stopper 6, the compression side leaf valve 7, and the piston 3 are fixed to the piston rod 2 by being sandwiched between the piston nut 9 screwed to the screw portion 2d at the distal end of the small-diameter portion 2a and the step portion 2c of the piston rod 2, and the movable body 10 and the coil spring 11 are arranged on an outer circumference of the piston nut 9. In this manner, the piston nut 9 is screwed to the small-diameter portion 2a of the piston rod 2 and functions as a facing member immovable with respect to the piston 3 in the damping valve V. The facing member may be integrated with the valve seat member to form a single component with the valve seat member, or may be separated from the valve seat member as described above. Therefore, in the present embodiment, the piston 3 serving as a valve seat member may be integrally provided with the facing member.

As illustrated in FIGS. 2 and 2, the piston 3 has an annular shape, is fixed to the outer circumference of the small-diameter portion 2a of the piston rod 2, is in sliding contact with the inner circumference of the cylinder 1, and partitions the inside of the cylinder 1 into an extension side chamber R1 on an upper side in FIG. 1 and a compression side chamber R2 on a lower side in FIG. 1. In addition, the piston 3 includes an extension side port 3a serving as a port extending from an upper end to a lower end to allow communication between the extension side chamber R1 and the compression side chamber R2, a compression side port 3b similarly extending from the upper end to the lower end to allow communication between the extension side chamber R1 and the compression side chamber R2, an extension side valve seat 3c serving as a valve seat provided on an outer circumferential side at an outlet end of the extension side port 3a, which is a lower end in FIG. 2, to surround the extension side port 3a, and a compression side valve seat 3d provided at an upper end in FIG. 2 to surround the compression side port 3b. In the damping valve V of the present embodiment, the extension side port 3a and the compression side port 3b are formed by a plurality of ports provided side by side along a circumferential direction of the piston 3, and the extension side port 3a is provided closer to an inner circumferential side of the piston 3 than the compression side port 3b.

In addition, the extension side valve seat 3c has an annular shape, and protrudes downward from the lower end in FIG. 2 of the piston 3 between the extension side port 3a and the compression side port 3b to surround a downstream opening of the extension side port 3a facing the compression side chamber R2. On the other hand, the compression side valve seat 3d has a petal shape, and protrudes upward from the upper end in FIG. 2 of the piston 3 to individually surround downstream openings of the compression side port 3b facing the extension side chamber R1.

The extension side leaf valve 8 is stacked on the lower end in FIG. 2 of the piston 3 as a valve body having an annular shape and fitted onto the outer circumference of the small-diameter portion 2a of the piston rod 2 to pen and close the extension side port 3a. The extension side leaf valve 8 is a laminate leaf valve formed by stacking a plurality of annular plates, and an inner circumferential side of the extension side leaf valve 8 is fitted to the small-diameter portion 2a of the piston rod 2 while the extension side leaf valve 8 is immovably fixed to the small-diameter portion 2a by the piston nut 9, allowing deflection of the extension side leaf valve 8 on its outer circumferential side. In the damping valve V of the present embodiment, a spacer 13 having a smaller outer diameter than the extension side leaf valve 8 is interposed between the extension side leaf valve 8 and the piston nut 9 on the outer circumference of the small-diameter portion 2a of the piston rod 2, and the extension side leaf valve 8 is deflected downward in FIG. 2 with an outer circumferential edge of the spacer 13 as a fulcrum by the action of the pressure of the extension side port 3a.

Then, in a state where the extension side leaf valve 8 is seated on the extension side valve seat 3c provided at the lower end of the piston 3, the extension side leaf valve 8 closes the outlet end at the lower end of the extension side port 3a. When the outer circumferential side of the extension side leaf valve 8 is deflected such that the extension side leaf valve 8 is separated from the extension side valve seat 3c, the extension side port 3a is opened, and a resistance is given to a flow of liquid passing through the extension side port 3a from the extension side chamber R1 toward the compression side chamber R2. The extension side leaf valve 8 is seated on the extension side valve seat 3c to close the extension side port 3a with respect to a flow of liquid from the compression side chamber R2 toward the extension side chamber R1. In a case where an upper end in FIG. 2 of the piston nut 9 is brought into abutment against an inner circumference of the piston 3, the extension side leaf valve 8 may be fitted onto the entire outer circumference of the piston nut 9 so as to be movable in the axial direction so that the piston nut 9 can move toward and away from the piston 3.

The compression side leaf valve 7 having an annular shape and fitted onto the outer circumference of the small-diameter portion 2a of the piston rod 2 is stacked on the upper end of the piston 3 in FIG. 2 to open and close the compression side port 3b. The compression side leaf valve 7 is laminate leaf valve formed by stacking a plurality of annular plates, and an inner circumferential side of the compression side leaf valve 7 is fixed to the small-diameter portion 2a of the piston rod 2, allowing deflection of the compression side leaf valve 7 on its outer circumferential side. Then, in a state where the compression side leaf valve 7 is seated on the compression side valve seat 3d at the upper end of the piston 3, the compression side leaf valve 7 closes an outlet end at an upper end of the compression side port 3b. When the outer circumferential side of the compression side leaf valve 7 is deflected such that the compression side leaf valve 7 is separated from the compression side valve seat 3d, the compression side port 3b is opened, and a resistance is given to a flow of liquid passing through the compression side port 3b from the compression side chamber R2 toward the extension side chamber R1. The compression side leaf valve 7 is seated on the compression side valve seat 3d to close the compression side port 3b with respect to a flow of liquid from the extension side chamber R1 to the compression side chamber R2. The valve stopper 6 is stacked on the compression side leaf valve 7 in FIG. 2. When the compression side leaf valve 7 is greatly deflected, the valve stopper 6 abuts against a piston-opposite side of the compression side leaf valve 2 to support the compression side leaf valve 7, and prevents excessive stress from acting on the compression side leaf valve 7 to protect the compression side leaf valve 7. In a case where the shock absorber D is configured as a double-cylinder shock absorber, a check valve that hardly gives a resistance to a flow of liquid when the valve is opened may be provided instead of the compression side leaf valve 7.

The piston nut 9 includes a cylindrical portion 9a having a cylindrical shape, an annular fixed spring seat 9b provided on an outer circumference at a lower end in FIG. 2 of the cylindrical portion 9a, a screw portion 9c provided on a lower side of an inner circumference of the cylindrical portion 9a and screwed to the screw portion 2d of the piston rod 2, an annular groove 9d provided in the outer circumference of the cylindrical portion 9a, and a hole 9e open from the inner circumference of the cylindrical portion 9a and extending to the annular groove 9d.

An outer diameter of a portion on a proximal end side of the cylindrical portion 9a of the piston nut 9 above the fixed spring seat 9b is larger than an outer diameter on a distal end side that is an upper side of the cylindrical portion 9a, and the cylindrical portion 9a has a small-diameter portion 9a1 and a large-diameter portion 9a2. Note that the fixed spring seat 9b is a portion that receives a biasing force of a coil spring 11 to be described later, and the piston nut 9 and the fixed spring seat 9b may be configured as separate components as long as the fixed springs seat 9b is attached to the piston nut 9 in an axially immovable manner.

The annular groove 9d is provided along the circumferential direction in the outer circumference of the small-diameter portion 9a1 of the cylindrical portion 9a at a position not facing the screw portion 9c in the radial direction, that is, above the screw portion 9c in FIG. 2. The hole 9e is open from the inner circumference of the cylindrical portion 9a above the screw portion 9c to a bottom portion of the annular groove 9d.

When the piston nut 9 configured in this manner is screw-fastened to the small-diameter portion 2a of the piston rod 2, the cylindrical portion 9a of the piston nut 9 and the step portion 2c sandwich the extension side leaf valve 8, the piston 3, the compression side leaf valve 7, and the valve stopper 6 to be fixed to the small-diameter portion 2a.

In addition, a groove 2e communicating with the extension side chamber R1 is provided from the small-diameter portion 2a to the step portion 2c of the piston rod 2, and the groove 2e and the hole 9e face each other and communicate with each other when the piston nut 9 is screwed to the screw portion 2d. Therefore, the annular groove 9d of the piston nut 9 communicates with the extension side chamber R1, which is located upstream of the extension side port 3a, via the hole 9e and the groove 2e. In the present embodiment, an inner diameter of the cylindrical portion 9a of the piston nut 9 above the screw portion 9c is larger than the outer diameter of the small-diameter portion 2a of the piston rod 2. Therefore, even if the groove 2e and the hole 9e are misaligned in the circumferential direction, the groove 2e and the hole 9e can reliably communicate with each other through an annular gap between the cylindrical portion 9a and the small-diameter portion 2a.

The annular contact body 12 is placed in the annular groove 9d of the piston nut 9 as a friction member formed of an elastic body. Specifically, the contact body 12 is an O-ring, and the pressure in the extension side chamber R1 acts on an inner circumferential side of the contact body 12 through the annular groove 9d, the hole 9e, and the groove 2e. Therefore, the pressure of the extension side chamber R1, which is located upstream of the extension side port 3a, acts on the contact body 12 in a direction to expand the diameter of the contact body 12. In this manner, the pilot passage P, which causes the pressure of the extension side chamber R1 located upstream of the extension side port 3a to act on the contact body 12 so as to press the contact body 12 toward an outer circumferential side of the piston nut 9, is formed by the annular groove 9d, the hole 9e, and the groove 2e. Note that the pilot passage P may be formed by a configuration other than the specific configuration described above, as long as it is provided to cause the pressure of the extension side chamber R3 upstream of the extension side port 3a serving as a port to act on the contact body 12 so that the contact body 12 can be pressed toward the movable body 10 to be described later. Therefore, for example, the pilot passage P may include a passage passing through the inside of the piston rod 2 or may include a passage provided in the piston 3.

A difference between inner and outer diameters of the contact body 12 is larger than a difference between inner and outer diameters of the annular groove 9d of the piston nut 9, the inner diameter of the contact body 12 is slightly smaller than the inner diameter of the annular groove 9d, and the contact body 12 tightens the bottom portion of the annular groove 9d and protrudes in the radial direction out of the annular groove 9d even in a situation where the contact body 12 is placed in the annular groove 9d with no load and no force acting thereon. In addition, the contact body 12 can be displaced in the radial direction with respect to the piston nut 9 serving as a facing member by expanding in diameter in the annular groove 9d, and the contact body 12 expands in diameter to increase its outer diameter when the pressure of the extension side chamber R1 acting on the contact body 2 through the pilot passage P increases.

Next, the movable body 20 is annular, and includes a cylindrical fitting portion 10a, an annular bearing portion 10b provided in a flange shape on an outer circumference at an end portion on a piston side of the fitting portion 10a, a contact body facing portion 10c protruding to an inner circumferential side in a middle portion or an inner circumference, and a relief portion 10d provided adjacent to a piston side of the contact body facing portion 10c on the inner circumference. Then, the movable body 20 is disposed on the outer circumference of the small-diameter portion 9a1 of the piston nut 9. That is, the piston nut 9 is inserted into the movable body 10. In addition, the movable body 10 is allowed to move in the axial direction of the piston nut 9 within the range of the entire length of the small-diameter portion 9a1 of the piston nut 9.

The contact body facing portion 10c has the smallest inner diameter at a central portion 10c1 in the axial direction, and includes inclined surfaces 10c2 and 10c3 on both sides in the axial direction of the central portion 10c1, where the contact body facing portion 10c has an inner diameter that gradually increase as being farther away from the central portion 10c1. The inner diameter of the central portion 10c1 is sufficiently larger than the outer diameter of the small-diameter portion 9a1, which is a movement range of the movable body 10, of the piston nut 9, and when the small-diameter portion 9a1 of the piston nut 9 is inserted into the movable body 10, an annular gap is formed between the inner circumference of the movable body 10 and the outer circumference of the small-diameter portion 9a1 of the piston nut 9. The inclined surface 10c2 is adjacent to the piston side of the central portion 10c1, and is a surface inclined in such a manner that the contact body facing portion 10c has an inner diameter that gradually increases as being farther away from the central portion 10c1 in the axial direction of the movable body 10. Note that the inclined surface 10c2 may be a tapered surface or a curved surface, or the inclination angle of the inclined surface 10c2 may change midway. The relief portion 10d is continuous with an end on a piston side of the inclined surface 10c2 of the contact body facing portion 10c, and has an inner diameter larger than the inner diameter of the central portion 10c1.

Then, the movable body 10 is disposed on the outer circumferential side of the small-diameter portion 9a1 of the piston nut 9, and is movable in a vertical direction, which is the axial direction of the piston nut 9, with respect to the piston nut 9. The movable body 10 overlaps a surface on a piston-opposite side of the extension side leaf valve 8 serving as a valve body, and can be separated from and seated on the extension side valve seat 3c serving as a valve seat via the extension side leaf valve 8. The movable body 10 can move in the vertical direction in FIG. 2 with respect to the piston nut 9, but the movement range of the movable body 10 is a range facing the small-diameter portion 9a1 of the piston nut 9, and the movable body 10 can move in the axial direction of the piston nut 9 without coming into contact with the piston nut 9 (in a non-contact manner) unless receiving a lateral external force.

In a state where the movable body 10 is at a position (initial position) in contact with the piston-opposite side of the extension side leaf valve 8 seated on the extension side valve seat 3c, the contact body facing portion 10c having the smallest inner diameter of the movable body 10 faces the contact body 12 placed in the annular groove 9d of the piston nut 9 in the radial direction. In the damping valve V of the present embodiment, the inner diameter of the central portion 10c1 of the contact body facing portion 10c is slightly smaller than the outer diameter of the contact body 12 placed in the annular groove 9d of the piston nut 9. When the contact body facing portion 10c faces the contact body 12 in the radial direction, the movable body 10 and the contact body 12 come into contact with each other, and a frictional force that hinders the downward movement of the movable body 10 in FIG. 2 is generated between the contact body 12 and the movable body 10. In this manner, the contact body 12 is provided in the piston nut 9 as a facing member so as to come into contact with the movable body 10. Note that the inner diameter of the relief portion 10d on a side adjacent to the piston of the contact body facing portion 10c is sufficiently larger than the outer diameter of the contact body 12, and is a diameter that prevents the contact body 12 from coming into contact with the relief portion 10d even though the contact body 12 expands in diameter due to the pressure of the extension side chamber R1 as will be described later.

The coil spring 11 is interposed between the fixed spring seat 9b and the movable body 10 by being sandwiched between the fixed spring seat 9b of the piston nut 9 and the bearing portion 10b of the movable body 10, and constantly biases the movable body 10 abutting against the extension side leaf valve 8 in a direction to approach the piston 3 in the axial direction. The coil spring 11 exerts a biasing force on the extension side leaf valve via the movable body 10, and presses the extension side leaf valve 8 against the extension side valve sear 3c. Therefore, the valve opening pressure when the extension side leaf valve 8 is deflected and separated from the extension side valve seat 3c to open the extension side port 3a is set by the biasing force generated by the coil spring 11.

One end 11a, which is an end on a fixed spring seat side, of the coil spring 11 is fitted onto an outer circumference of the large-diameter portion 9a2 of the piston nut 9 inserted on an inner circumferential side of the coil spring 11 to tighten the large-diameter portion 9a2, and is fixed to the piston nut 9 so as to be immovable in the radial direction. In this manner, one end of the coil spring 11 is aligned with the piston nut 9 serving as a facing member by being fitted onto the outer circumference of the large-diameter portion 9a2 of the piston nut 9. Note that an annular component such as a washer may be provided between the fixed spring seat 9b and the coil spring 11 so that the piston nut 9 does not rotate due to expansion and contraction of the coil spring 11. In addition, the alignment of one end 11a of the coil spring 11 with respect to the piston nut 9, which is a facing member, may be performed by attaching a component to be fitted to the inner circumference of one end 11a of the coil spring 11 to the outer circumference of the cylindrical portion 9a of the piston nut 9, rather than fitting one end 11a of the coil spring 11 onto the large-diameter portion 9a2 of the piston nut 9. That is, in order for one end 11a of the coil spring to be aligned in the radial direction by the piston nut 9, which is a shaft member, the coil spring 12 may be indirectly attached to the piston nut 9, which is a shaft member, as long as the coil spring 11 is fastened to the piston nut 9 so as to be immovable in the radial direction, rather than directly attaching one end 11a of the coil spring 11 to the piston nut 9. Therefore, when the coil spring 11 is aligned with the piston nut 9, one end 11a of the coil spring 11 may be attached to the piston nut 9 by using welding or the like, or may be attached via a certain component.

Although it has been described above that the cylindrical coil spring 11 is used as a spring member, the spring member may be a cone-shaped, barrel-shaped, or package-shaped spring, and the spring member does not need to have a circular cross section and may be formed of a material other than metal as long as the movable spring seat 10 can be aligned.

In addition, the other end 11b, which is an end on a movable spring seat side, of the coil spring 11 is fitted onto an outer circumference of the fitting portion 10a of the movable body 10 inserted on the inner circumferential side of the coil spring 11 to tighten the fitting portion 10a and hold the movable body 10. The movable body 10 faces the outer circumference of the small-diameter portion 9a1 of the piston nut 9 via the annular gap, is held by fitting the other end 11b of the coil spring 11, and is aligned with the piston nut 9 by the coil spring 11. In this manner, the movable body 10 is aligned with the piston nut 9 by fitting the movable body 10 to the other end 11b of the coil spring 11, the movable body 10 is located at a position as designed with respect to the extension side leaf valve 8 and the piston 3 even though it is not in contact with the piston nut 9, so that the biasing force of the coil spring 11 is applied to the extension side leaf valve 8. In addition, the alignment of the movable body 10 by the other end 11b of the coil springe 11 may be performed by interposing another component, rather than by fitting the other end 11b of the coil spring 11 to the fitting portion 10a of the movable body 10. That is, in order for the movable body 10 to be aligned in the radial direction by the other end 11b of the coil spring, the movable body 10 may be attached to the coil spring 11 via another component, as long as the movable body 10 is fastened to the coil spring 11 so as to be immovable in the radial direction, rather than directly attaching the other end 11b of the coil spring 11 to the movable body 10. Therefore, when the movable body 10 is aligned by the coil spring 11, the other end 11b of the coil spring 11 may be attached to the bearing portion 10b by using welding or the like, or may be attached via a certain component. In a case where it is not necessary to align the movable body 10 with the piston nut 9 serving as a facing member via the coil spring 11, the coil spring 11 may be fitted to the piston nut 9 or the movable body 10 so as to be movable in the radial direction.

Next, the operations of the damping valve V and the shock absorber D configured as described above will be described. First, the operations of the damping valve V and the shock absorber D during the extension operation of the shock absorber D in which the piston 3 moves upward in FIG. 1 with respect to the cylinder 1 will be described. When the piston 3 moves upward in FIG. 1 with respect to the cylinder 1, the extension side chamber R1 is reduced and the compression side chamber R2 is enlarged in accordance with the movement of the piston 3. The liquid in the reduced extension side chamber R1 tries to pass through the extension side port 3a to deflect the extension side leaf valve 8. In a state where the extension speed of the shock absorber D is low and the difference between the pressure of the extension side chamber R1 and the pressure of the compression side chamber R2 does not reach the valve opening pressure, the force that deflects the extension side leaf valve 8 due to the action of the pressure of the liquid passing through the extension side port 3a cannot overcome the biasing force of the coil spring 11, and the extension side leaf valve 8 remains seated on the extension side valve seat 3c. In such a state, the liquid moves from the extension side chamber R1 to the compression side chamber R2 through an orifice formed by a recess (not illustrated) provided in the extension side valve seat 3c or the compression side valve seat 3d, and the orifice gives a resistance to the flow of the liquid. Therefore, in a state where the extension speed of the shock absorber D is low and the difference between the pressure of the extension side chamber R1 and the pressure of the compression side chamber R2 does not reach the valve opening pressure, the damping valve V generates a damping force that hinders the extension of the shock absorber P through the orifice (not shown). Rather than being provided in the extension side valve seat 3c or the compression side valve seat 3d, the orifice may be formed by a notch provided in an outer circumference of an annular plate in contact with the extension side valve seat 3W of the extension side leaf valve 8 or a notch provided in an outer circumference of an annular plate in contact with the compression side valve seat 3d of the compression side leaf valve 7. In addition, during the extension operation of the shock absorber D, the piston rod 2 is retracted from the inside of the cylinder 1, reducing the volume of the piston rod 2 pushed down in the cylinder 1, but the free piston 5 moves up in FIG. 1 in the cylinder 1, increasing the volume of the gas chamber G, thereby compensating for the volume of the piston rod 2 retracted from the inside of the cylinder 1.

On the other hand, when the extension speed of the shock absorber D increases and the difference between the pressure of the extension side chamber R1 and the pressure of the compression side chamber R2 is higher than or equal to the valve opening pressure, the outer circumferential side of the extension side leaf valve 8 is deflected due to the pressure in the extension side chamber R1 acting through the extension side port 3a, and the movable body 10 also retreats from the piston 3, contracting the coil spring 11, so that the extension side port 3a is opened and the liquid in the extension side chamber R2 passes through the gap between the extension side leaf valve 8 and the extension side valve seat 3c and moves to the compression side chamber R2. Therefore, in this case, the extension side leaf valve 8 gives a resistance to the flow of the liquid passing through the extension side port 3a, so that the shock absorber D generates an extension side damping force that suppresses the extension operation.

In the damping valve V of the present embodiment, the pressure in the extension side chamber R1, which is upstream of the extension side port 3a, acts in a direction to expand the diameter of the contact body 12 via the pilot passage P and pressing the contact body 12 toward the contact body facing portion 10c of the movable body 10. Then, when the pressure of the extension side chamber R1 acting on the inner circumferential side of the contact body 12 increases, the contact body 12 is pressed by the pressure and expands in diameter to increase its outer diameter, and is displaced toward the movable body 10 facing the contact body 12 in the radial direction and pressed against the movable body 10 by the pressure.

Therefore, as the extension speed of the shock absorber D increases, the difference between the pressure of the extension side chamber R1 and the pressure of the compression side chamber R2 increases, and accordingly, the force pressing the contact body 12 against the movable body 10 increases, thereby increasing the frictional force between the contact body 12 and the movable body 10. The contact body 12 is accommodated in the annular groove 9d on the outer circumference of the piston nut 9, which is as a facing member, and movement of the contact body 12 in the axial direction with respect to the piston nut 9 is restricted. Therefore, when the frictional force generated between the contact body 12 and the movable body 10 increases, it is difficult for the movable body 10 to move in the axial direction with respect to the piston nut 9. Therefore, as the extension speed of the shock absorber D increases, it is difficult for the movable body 10 to move in the axial direction, increasing the difference between the pressure of the extension side chamber R1 and the pressure of the compression side chamber R2 required to press down and separate the extension side leaf valve 8 and the movable body 10 in FIG. 2 from the extension side valve seat 3c, that is, increasing the valve opening pressure of the damping valve V. In this manner, in the damping valve V of the present embodiment, the valve opening pressure changes in response to the extension speed of the shock absorber D.

In addition, since the inner diameter of the relief portion 10d adjacent to the piston side of the contact body facing portion 10c on the inner circumference of the movable body 10 is set to a diameter large enough to prevent the contact body 12 from coming into contact with the relief portion 10d, when the movable body 10 retreats from the piston 3 and the damping valve V is opened, the contact body 12 is misaligned in the axial direction with respect to the contact body facing portion 10c and faces the relief portion 10d, thereby preventing the contact body 12 from suppressing the movement of the movable body 10. Therefore, after the damping valve V is opened, the coil spring 11 contracts according to the extension speed of the shock absorber D to open the extension side port 3a, so that the damping valve V realizes a damping force characteristic in which the damping force is saturated even if the extension speed of the shock absorber D increases.

In addition, in the contact body facing portion 10c provided on the inner circumference of the movable body 10, the central portion 10c1 has the smallest diameter, and the inclined surface 10c2, where the contact body facing portion 10c has an inner diameter that increases as being farther away from the central portion 10c1, is provided on the piston side of the central portion 10c. Therefore, when the movable body 10 returns to its initial position, the contact body 12 comes into contact with the inclined surface 10c2 earlier than the center of the contact body facing portion 10c, so that the diameter of the contact body 12 gradually decreases. Therefore, when the movable body 10 returns to its initial position, its movement is not suddenly hindered by the contact body 12, and the movable body 10 can quickly return to the initial position.

In the damping valve V of the present embodiment, the contact body 12 is in contact with the movable body 10 even in an unloaded state in which no force acts on the contact body 12. However, even though the contact body 12 is placed in the annular groove 9d, the outer circumference of the contact body 12 may not be in contact with the contact body facing portion 10c of the movable body 10 in the unloaded state. When the difference between the pressure of the extension side chamber R1 and the pressure of the compression side chamber R2 becomes higher than or equal to a predetermined pressure, the contact body 12 that receives the pressure of the extension side chamber R1 through the pilot passage P and expands in diameter may come into contact with the contact body facing portion 10c to suppress the movement of the movable body 10. By doing so, in the speed range of the extension speed of the shock absorber D in which the difference between the pressure of the extension side chamber R1 and the pressure of the compression side chamber R2 does not reach the predetermined pressure, it is possible to provide a dead zone in which the contact body 12 does not contact the movable body 10 and the valve opening pressure in the damping valve V is not responsive to the extension speed of the shock absorber D.

When the damping valve V of the present embodiment is opened, the coil spring 11 contracts and the extension side leaf valve 8 is deflected to open the extension side port 3a. However, since the movable body 10 is aligned with the piston nut 9 by the coil spring 11, the movable body 10 can retract in the axial direction from the piston 3 without interfering with the piston nut 9 serving as a facing member. Even if the coil spring 11 applies an unbalanced load to the movable body 10, the extension side leaf valve 8 is not uniformly deflected around the entire circumference, or a dimensional error occurs in each component of the damping valve V such as the piston nut 9 serving as a facing member, the piston 3 serving as a valve seat member, or the movable body 10, the movable body 10 can move toward and away from the piston 3 without interfering with the piston nut 9. Therefore, the movable body 10 can move smoothly with respect to the piston nut 9 without causing stick-slip, and has no adverse effect on the valve opening pressure or deflection of the extension side leaf valve 8.

On the other hand, during the contraction operation of the shock absorber D in which the piston 3 moves downward in FIG. 1 with respect to the cylinder 1, the compression side chamber R2 is reduced and the extension side chamber R is enlarged in accordance with the movement of the piston 3. The liquid in the reduced compression side chamber R2 passes through the compression side port 3b, deflects the compression side leaf valve 7, and moves to the extension side chamber R1. Therefore, during the contraction operation of the shock absorber D, the compression side leaf valve 7 gives a resistance to a flow of liquid passing through the compression side port 3b, causing the pressure in the compression side chamber R2 to become higher than the pressure in the extension side chamber R1, and the shock absorber D generates a compression side damping force that suppresses the contraction operation. In addition, during the contraction operation of the shock absorber D, the piston rod 2 enters the cylinder 1, increasing the volume of the piston rod 2 pushed down in the cylinder 1, but the free piston 5 moves down in FIG. 1 in the cylinder 1, reducing the volume of the gas chamber G, thereby compensating for the volume of the piston rod 2 entering the cylinder 1. When the shock absorber D changes from the extension operation to the contraction operator, the movable body 10 returns to the position (initial position) closest to the piston 3 together with the extension side leaf valve 8 due to the biasing force of the coil spring 11. However, the pressure of the compression side chamber R2 becomes higher than the pressure of the extension side chamber R1, and the pressure of the extension side chamber R1 received from the pilot passage P also decreases. Therefore, the diameter of the contact body 12 is reduced by its self-restoring force and the contact body 12 retracts into the annular groove 9d, and the frictional force between the contact body facing portion 10c and the contact body 12 also decreases when the movable body 10 returns to its original position. Therefore, when the shock absorber D changes from the extension operation to the contraction operation, the movable body 10 can quickly return to its initial position. Note that, in a case where the contact body 12 is not in contact with the movable body 10 in the unloaded state, the movable body 10 returns to the initial position without receiving a resistance from the contact body 12.

As described above, the damping valve V of the present embodiment includes: a piston (valve seat member) 3 having an extension side port (port) 3a and an extension side valve seat (valve seat) 3c surrounding the extension side port (port) 3a; a movable body 10 movable in a direction toward and far away from the extension side valve seat (valve seat) 3c; a piston nut (facing member) 9 facing the movable body 10 and immovable with respect to the piston (valve seat member) 3; a contact body 12 provided to be displaceable toward the movable body 10 with respect to the piston nut (facing member) 9 to come into contact with the movable body 10; and a pilot passage P causing pressure upstream of the extension side port (port) 3a to act on the contact body 12 so as to press the contact body 12 toward the movable body 10.

According to the damping valve V configured in this manner, when the extension speed of the shock absorber D is high and the difference between the pressure of the extension side chamber R1 and the pressure of the compression side chamber R2 increases, the force pressing the contact body 12 against the movable body 10 increases, thereby increasing the frictional force generated between the contact body 12 and the movable body 10. Therefore, according to the damping valve V of the present embodiment, when the pressure of the extension side chamber R1, which is located upstream of the extension side port 3a, increases, the frictional force between the contact body 12 and the movable body 10 increases, and the valve opening pressure for opening the extension side port (port) 3a increases, making it possible to adjust the damping force characteristics depending on the pressure upstream of the extension side port (port) 3a. In addition, in the damping valve V of the present embodiment, the valve opening pressure can be tuned by setting the force with which the contact body 12 restrains the movable body 10 at the initial position. Further, since the extension side leaf valve (valve body) 8 is provided in the damping valve V of the present embodiment, if the movable body 10 is integrated with the extension side leaf valve (valve body) 8 by welding or the like, the movable body 10 can be aligned with the piston nut 9 and the piston 3 serving as facing members, and the movable body 10 can be returned to its initial position by the restoring force exerted by the extension side leaf valve (valve body) 8, so that the coil spring 11 and the fixed spring seat 9b can be eliminated.

In addition, in the damping valve V of the present embodiment, the movable body 10 is annular, the piston nut (facing member) 9 is disposed on the inner circumferential side of the movable body 10 and has an annular groove 9d on its outer circumference, and the contact body 12 is an annular O-ring (elastic body) placed in the annular groove 3e. According to the damping valve V configured in this manner, with a simple configuration in which the annular groove 9d is provided in the piston nut (facing member) 9 and the annular contact body 12 is placed in the annular groove 3d, the contact body 12 receiving pressure of the extension side chamber R1, which is located upstream of the extension side port 3a, can be brought into contact with the movable body 10 to adjust the damping force characteristic depending on the pressure of the extension side chamber R1, which is located upstream of the extension side port (port) 3a. In addition, by adopting the structure in which the contact body 12 is an annular elastic body, and the contact body 12 presses the movable body 10 by expanding the diameter of the contact body 12 in the annular groove 9d of the piston nut (facing member) 9 as described above, the damping valve V can be easily assembled. Also, since the diameter of the contact body 12 is reduced by its own restoring force as the pressure in the extension side chamber R1 decreases, when the shock absorber D performs the extension operation and then performs the contraction operation, the contact body 12 does not hinder the return of the movable body 10 to its initial position. Further, since the contact body 12 can be brought into abutment against the side wall facing the contact body 12 of the annular groove 9d to seal the inside of the annular groove 9d, the pressure of the extension side chamber R1 is prevented from leaking from the pilot passage P to the compression side chamber R2. In addition, in the damping valve V configured in this manner, the valve opening pressure can be easily tuned by setting the elastic coefficient of the contact body 12, which is an elastic body, and the pressure receiving area of the contact body 12 that receives the pressure of the extension side chamber R1. In addition, in the damping valve V of the present embodiment, since the pilot passage P causes the pressure of the extension side chamber R1, which is located upstream of the extension side port 3a, to act on the inner circumference in the radial direction of the annular contact body 12, which is an elastic body, the contact body 12 can be pressed against the movable body 10 by expanding in diameter due to the pressure of the extension side chamber R1, and the contact body 12 can be efficiently pressed against the movable body 10 to apply a resistance corresponding to the pressure to the movable body 10 while preventing pressure leakage from the inside of the annular groove 9d.

Note that the shape of the contact body 12 does not need to be annular, and can be changed to any shape, as long as the contact body 12 is capable of increasing the force that restrains the movement of the movable body 10 in the axial direction with respect to the piston nut (facing member) 9 according to the magnitude of the pressure of the extension side chamber R1 required to bring the contact body 12 into contact with and act on the movable body 10, which is a frictional force in this case. Therefore, for example, a hole open from the outer circumference to the inner circumference of the piston nut (facing member) 9 and communicating with the groove 2e of the piston rod 2 may be provided, and the contact body 12 may be inserted into the hole so as to move toward and away from the movable body 10.

Furthermore, in the damping valve V of the present embodiment, the movable body 10 is annular, the piston nut facing member) 9 is disposed on the inner circumferential side of the movable body 10. The damping valve V of the present embodiment includes a fixed spring seat 9b provided in the piston nut (facing member) 9 and a coil spring (spring member) 11 interposed between the movable body 10 and the fixed spring seat 9b. One end of the coil spring (spring member) 11 is aligned in the radial direction with the piston nut (facing member) 9, and the movable body 10 has an inner diameter larger than an outer diameter of the piston nut (facing member) 9 in a movement range of the movable body 10, and is aligned in the radial direction by the other end of the coil spring (spring member) 11.

According to the damping valve V configured in this manner, since the movable body 10 is aligned with the piston nut (facing member) 9 by the coil spring (spring member) 11, when the coil spring (spring member) 11 contracts and the extension side leaf valve (valve body) 8 is deflected to open the extension side port (port) 3a, the movable body 10 can retract in the axial direction from the piston (valve seat member) 3 without interfering with the piston nut (facing member) 9. As described above, according to the damping valve V, the movable body 10 can move toward and away from the piston (valve seat member) 3 without interfering with the piston nut (facing member) 9, so that the movable body 10 can move smoothly with respect to the piston nut (facing member) 9 without causing stick-slip, and has no adverse effect on the valve opening pressure or deflection of the extension side leaf valve 8. As described above, according to the damping valve V of the present embodiment, it is possible to generate a stable damping force without variation, and there is no need to increase the precision in processing each component constituting the damping valve V or to perform highly accurate dimensional management, as a result causing no increase in manufacturing cost.

In addition, in the damping valve V of the present embodiment, since the movable body 10 is biased by the coil spring (spring member) 11, the damping force characteristic can be tuned by tuning the spring constant of the coil spring (spring member) 11 and the biasing force (initial load) that the coil spring (spring member) 11 gives to the movable body 10 in a state where the movable body 10 is at the initial position, as well as tuning the valve opening pressure by setting the force with which the contact body 12 restrains the movable body 10 at the initial position, thereby improving the degree of freedom in designing the damping force characteristic.

In addition, in the damping valve V of the present embodiment, since the outer diameter of the small-diameter portion (portion) 9a1 facing the movement range of the movable body 10 of the piston nut (shaft member) 9 is smaller than the inner diameter of the movable body 10, and the annular gap is formed between the small-diameter portion (portion) 9a1 and the movable body 10, the movable body 10 can be aligned only by the coil spring (spring member) 11, preventing interference with the piston nut (facing member) 9 to prevent an occurrence of stick-slip. Note that the difference between the outer diameter of the small-diameter portion (portion) 9a1 facing the movement range of the movable body 10 of the piston nut (facing member) 9 and the inner diameter of the movable body 10 may be set such that the movable body 10 does not interfere with the piston nut (facing member) 9 due to vibration and operation input to the damping valve V. Therefore, it is preferable to set the difference in consideration of the rigidity of the coil spring (spring member) 11 in the lateral direction.

Further, in the damping valve V of the present embodiment, the movable body 10 includes a fitting portion 10a fitted onto the inner circumference of the other end 11b of the coil spring 11, and is aligned by fitting the other end 11b of the coil spring 11 to the fitting portion 10a. According to the damping valve V configured in this manner, since the movable body 10 can be aligned with a simple configuration in which the movable body 10 is fitted to the coil spring 11, processing is easy, and the manufacturing cost is low.

In addition, in the damping valve V of the present embodiment, the contact body 12 is formed of an O-ring (friction member) that generates a frictional force between the contact body 12 and the movable body 10 when coming into contact with the movable body 10. In the damping valve V configured in this manner, the force that restrains the axial movement of the movable body 10 with respect to the piston nut (facing member) 9 is obtained by the frictional force between the contact body 12 and the movable body 10. Therefore, a frictional force corresponding to the pressure of the extension side chamber R1 located upstream of the extension side port (port) 3a can be generated to change the valve opening pressure of the damping valve V without performing special processing on the contact body 12 and the movable body 10.

Further, in the damping valve V of the present embodiment, the movable body 10 includes a relief portion 10d located adjacent to the piston (valve seat member) side of the contact body facing portion 10c on an inner circumferential surface (surface) facing the piston nut (facing member), while not being in contact with the contact body 12, the contact body facing portion 10c facing the contact body 12 when the movable body 10 is closest to the piston (valve seat member) 3. In this manner, the contact body 12 does not contact the relief portion 10d adjacent to the piston side of the contact body facing portion 10c on the inner circumference of the movable body 10. Therefore, when the movable body 10 retreats from the piston 3 and the damping valve V is opened, the contact body 12 is misaligned in the axial direction with respect to the contact body facing portion 10c and faces the relief portion 10d, thereby preventing the contact body 12 from suppressing the movement of the movable body 10.

Therefore, after the damping valve V is opened, the coil spring 11 contracts according to the extension speed of the shock absorber D to open the extension side port 3a. Therefore, while the damping valve V changes the damping force characteristic depending on the pressure of the extension side chamber R1 located upstream of the extension side port (port) 3a, the damping valve V can realize a damping force characteristic in which the damping force is saturated even if the extension speed of the shock absorber D increases after the damping valve V is opened.

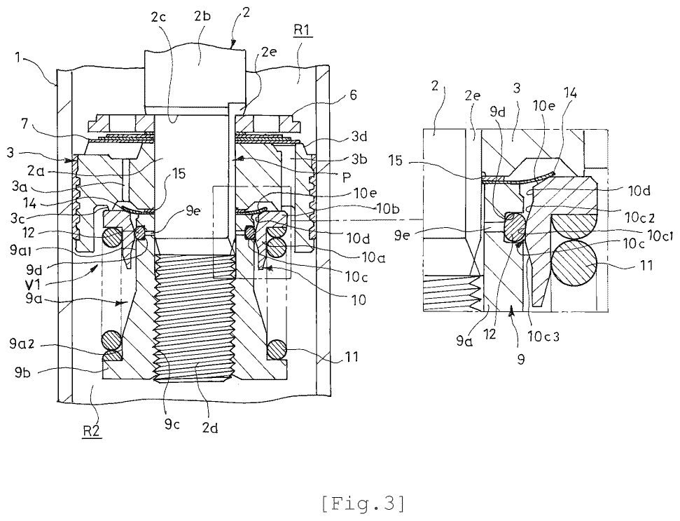

Although it has been described above that the movable body 10 is separated from and seated on the extension side valve seat 3c via the extension side leaf valve 8 using the extension side leaf valve as a valve body, the extension side leaf valve 8 may be eliminated, and the movable body 10 may be separated from and seated on the extension side valve seat 3c, whereby the extension side port 3a is opened and closed by the movable body 10, using the movable body 10 as a valve body, as in a damping valve V1 illustrated in FIG. 3. In this case, an annular gap is provided between the movable body 10 and the small-diameter portion 9a1 of the piston nut 9, and the extension side port 3a always communicates with the compression side chamber R2 through the annular gap. Therefore, a seal member 14 that closes the gap between the piston nut 9 and the movable body 10 is provided. In a case where the contact body 12 functions as a seal when the contact body 12 abuts against the contact body facing portion 10c of the movable body 10, the seal member 14 does not need to be provided.

The seal member 14 is formed of an annular leaf spring sandwiched between the cylindrical portion 9a of the piston nut 9 and the inner circumferential portion of the piston 3. Specifically, the seal member 14 is a leaf spring made of an annular plate having elasticity, and is fixed to the piston rod 2 by being sandwiched between the cylindrical portion 9a of the piston nut 9 screwed to the piston rod 2 and the step portion 2c after being placed on the outer circumference of the small-diameter portion 2a of the piston rod 2 together with an annular spacer 15 whose inner circumference overlaps the inner circumferential portion of the piston 3.

The spacer 15 has an outer diameter smaller than an outer diameter of the seal member 14. The inner circumferential side of the seal member 24 is fixed while deflection of the outer circumference of the seal member 14 is allowed, and the outer circumference of the seal member 14 abuts against an inner circumference of an end surface on a piston side at an upper end in FIG. 3 of the movable body 10. In a state where the movable body 10 is seated on the extension side valve seat 3c, the outer circumference of the seal member 14 is deflected upward in FIG. 3 and is in tight contact with the movable body 10 by a resilient force generated by the seal member 14 itself. Since the seal member 14 is in tight contact with the movable body 10 in a state where the movable body 10 is seated on the extension side valve seat 3c in this manner, the annular gap between the piston nut 9 and the movable body 10 can be prevented from communicating with the extension side port 3a, and the movable body 10 can close the extension side port 3a in cooperation with the seal member 14 when seated on the extension side valve seat 3c. The spacer 15 is provided for the purpose of adjusting the timing at which the seal member 14 abuts against the movable body 10, as well as allowing deflection of the outer circumference of the seal member 14 toward the piston. Note that the spacer 15 may be formed of a plurality of annular plates. By forming the spacer 15 of a number of stacked annular plates, it is possible to enjoy an advantage that the abutment timing can be easily adjusted.

Note that the seal member 14 may be formed of an O-ring or the like placed on the outer circumference at a distal end of the cylindrical portion 9a of the piston nut 9, as long as it is capable of preventing the annular gap between the piston nut 9 and the movable body 10 from communicating with the extension side port 3a in a state where the movable body 10 is seated on the extension side valve seat 3c.

In this manner, in the damping valve V1 of the first modification, the movable body 10 is directly separated from and seated on the extension side valve seat (valve seat) 3c to open and close the extension side port (port 3a, and the annular seal member 14 is provided to seal the gap between the movable body 10 and the piston nut (facing member) 9. Therefore, even in a case where the movable body 10 is used as a valve body, when the movable body 10 is seated on the extension side valve seat (valve seat) 3c, the extension side port (port) 3a is reliably closed, and a desired damping force can be generated.

In addition, in the damping valve V1 of the present embodiment, the seal member 14 is an annular leaf spring whose inner circumference is a fixed end fixed to the piston nut facing member) 9, while deflection of the outer circumference of the seal member 14 is allowed and the outer circumference abuts against the end surface on the piston (valve seat member) side of the movable body 10. According to the damping valve V1 configured in this manner, the annular gap between the piston nut (facing member) 9 and the movable body 10 can be prevented from communicating with the extension side port (port) 3a without affecting the function of the coil spring 11 for aligning the movable body 10. Therefore, even in a case where the movable body 10 functions as a valve body, interference between the movable body 10 and the piston nut (facing member) 9 is prevented, eliminating a disadvantage caused by stick-slip. In the damping valve V1 of the present embodiment, the seal member 14 is an annular leaf spring having a tapered surface 10e at an end on a piston side of the movable body 10 against which the seal member 14 abuts. Therefore, the movable body 10 can be aligned with the piston 3 serving as a valve seat member and the piston nut 9 serving as a racing member by the seal member 14. Therefore, in this case, the movable body 20 may be aligned only by the seal member 14 instead of the alignment of the movable body 10 using the coil spring 11. Even in a case where the movable body 10 is aligned by the seal member 14, an annular gap is provided between the movable body 10 and the small-diameter portion 9a1 of the piston nut 9, so that interference between the movable body 10 and the piston nut (facing member) 9 is prevented, eliminating a disadvantage caused by stick-slip.

In addition, by using a leaf spring for the seal member 14, the seal member 14 abuts against the movable body 10 before the movable body 10 is seated on the extension side valve seat 3c after being separated from the piston 3, generating a biasing force for suppressing the movement of the movable body 10 toward the piston, so that the collision between the movable body 10 and the extension side valve seat 3c can be buffered.

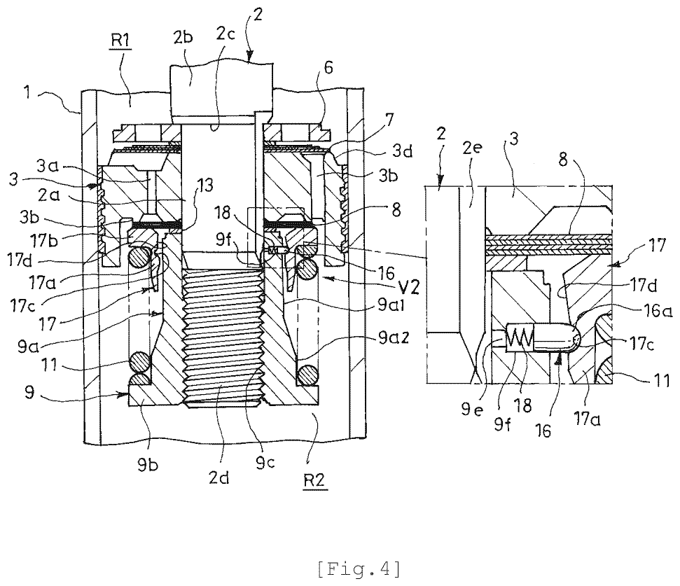

Further, as in a damping valve V2 of a second modification illustrated in FIG. 4, in a case where a contact body 16 is a metal pin, and is inserted into a hole 9f penetrating the cylindrical portion 9a of the piston nut 9 in the radial direction to bring the contact body 16 in contact with an inner circumference of a movable body 17, the movable body 17 can be suppressed from retreating from the piston 3. The contact body 16 has a columnar shape and includes a spherical surface 16a at a distal end thereof, and the contact body 16 is inserted into the hole 9f penetrating the small-diameter portion 9a1 in the cylindrical portion 9a of the piston nut 9 in the radial direction with the distal end thereof facing the outer circumferential side of the piston nut 9. The hole 9f has a circular cross section, with an opening on an inner circumferential side of the cylindrical portion 9a having a small diameter, and the contact body 16 is slidably inserted into a large-diameter portion of the hole 9f.

The opening of the hole 9f on the inner circumferential side of the piston nut 9 communicates with the extension side chamber R1, which is located upstream of the extension side port 3a, via groove 2e in the piston rod 2. Then, the pressure of the extension side chamber R1 acts on a rear end of the contact body 16 via the pilot passage P formed by the groove 2e, and the pressure biases the contact body 16 against the piston nut 3 in a direction to protrude from the inside of the hole 9f to the outside of the piston nut 9. Further, a spring 18 that biases the contact body 16 in a direction to protrude from the inside of the hole 9f is inserted in the large-diameter portion of the hole 9f, closer to the inner circumferential side of the piston nut 9 than the contact body 16.

The movable body 17 includes a cylindrical portion 17a, a bearing portion 27b on an outer circumference at an upper end in FIG. 4 of the cylindrical portion 17a, a recessed groove 17c allowing the contact body 16 to be inserted in an inner circumferential surface, which is a surface facing the piston nut facing member), and an inclined surface 17d provided adjacent to the piston (valve seat member) side of the recessed groove 17c on a surface facing the piston nut (facing member) and abuttable against the contact body 16, and approaching the piston nut (facing member) 9 as being farther away from the recessed groove 17c toward the piston (valve seat member).

The recessed groove 17c is provided in an annular shape along the circumferential direction on the inner circumference of the movable body 17 at a position facing the spherical surface 16a at the distal end of the contact body 16 provided in the piston nut 9 at an initial position where the movable body 27 abuts against the extension side leaf valve 8 seated on the extension side valve seat 3c on the inner circumference of the cylindrical portion 17a of the movable body 17. In addition, the recessed groove 17c has a cross section in a circular arc shape so as to correspond to the spherical surface 16a.

The inclined surface 17d is adjacent to the piston side of the recessed groove 17c, and is a surface inclined in such a manner that the movable body 17 has an inner diameter that gradually decreases as being farther away from the inclined surface 17d in the axial direction of the movable body 17. Note that the inclined surface 27d may be a tapered surface or a curved surface, or the inclination angle of the inclined surface 17a may change midway.

As described above, in the damping valve V2, the movable body 17 includes a recessed groove 17c allowing the contact body 16 to be inserted in an in an inner circumferential surface, which is a surface facing the piston nut (facing member), and an inclined surface 17d provided adjacent to the piston (valve seat member) side of the recessed groove 17c on a surface facing the piston nut (facing member) and abuttable against the contact body 16, and approaching the piston nut (facing member) 9 as being farther away from the recessed groove 17c toward the piston (valve seat member), and the damping valve V2 includes a spring 18 that biases the contact body 16 toward the movable body 17.

In the damping valve V2 configured in this manner, when the movable body 17 is disposed a the initial position, the spherical surface 16a of the contact body 16, whose distal end protrudes from the hole 9f of the piston nut 9 by receiving a biasing force of the spring 18, is fitted into the recessed groove 12c of the movable body 17. In order for the movable body 17 to move in a direction away from the piston 3 from the initial position, it is necessary to push away the contact body 16 and push the contact body 16 into the hole 9f, and a resistance is received when the contact body 16 is moved into the hole 9f. The contact body 16 is biased and pressed toward the movable body 17 in a direction to protrude from the hole 9f due to the pressure of the extension side chamber R1 is located upstream of the extension side port 3a via the pilot passage P, in addition to the biasing force of the spring 18. Therefore, as the difference between the pressure in the extension side chamber R1 and the pressure in the compression side chamber R2 increases, the contact body 16 is strongly pressed against the movable body 17, and the valve opening pressure necessary for moving the movable body 17 in a direction away from the piston 3 increases. Therefore, in the damping valve V2, similarly to the damping valve V, the valve opening pressure changes depending on the pressure of the extension side chamber R1, which is located upstream of the extension side port 3a. Therefore, according to the damping valve V2 of the present embodiment, it is possible to adjust the damping force characteristic depending on the pressure upstream of the extension side port (port) 3a.

In addition, when the movable body 17 moves in a direction away from the piston 3 from the initial position, the spherical surface 16a at the distal end of the contact body 16 comes out of the recessed groove 17c and slides on the inclined surface 17d, receiving a small resistance from the contact body 16 when the movable body 17 moves in the direction away from the piston 3. Therefore, after the damping valve V2 is opened, the movable body 17 can be quickly separated from the piston 3. In addition, when the shock absorber D switches from the extension operation to the contraction operation, the spherical surface 16a is pressed against the inclined surface 17d by the biasing force of the spring 18 to assist the movable body 17 in moving in a direction away from the piston 3 and returning to its initial position, so that the damping valve V2 is quickly closed, causing no delay in closing the extension side port 3a. In the damping valve V, since the contact body 26 is biased by the spring 18, if three or more contact bodies 16 are equally arranged in the circumferential direction with respect to the piston nut 9, the movable body 17 can be aligned with the piston 3 and the piston nut 9 by contacting the contact bodies 16, without having to perform alignment using the coil spring 11. In addition, since the movable body 17 includes the recessed groove 17c and the inclined surface 17d, and an initial load in a valve closing direction can be applied to the movable body 17 as the contact body 16 is biased by the spring 18. Thus, the coil spring 11 and the fixed spring seat 9b may be eliminated even when it is necessary to apply an initial load.

Although it has been described above that the movable body 10 or 17 is loosely fitted to the piston nut 9 serving as a facing member so as not to cause stick-slip, the movable body 10 or 17 can also be slidably placed on the outer circumference of the small-diameter portion 9a1 of the piston nut 9 serving as a facing member. In this case, it is preferable that the contact body 12 or 16 does not excessively hind-er the movement of the movable body 10 or 17 from its initial position in a direction away from the piston 3 when the pressure upstream of the port is extremely small.

Further, each of the damping valves V, V1, and V2 of the present embodiment uses the extension side port 3a as a port so that the extension side chamber R1 is located upstream of the port, but may be used as a compression side damping valve using the compression side port 3b as a port so that the compression side chamber R2 is located upstream of the port.

In each of the damping valves V, V1, and V2 of the present embodiment, the piston nut 9 is a facing member, but the piston rod 2 itself may be a facing member instead of the piston nut 9. Further, the facing member does not necessarily have a cylindrical shape or a columnar shape as long as the facing member faces the movable body while being immovable with respect to the valve seat member and provided with the contact body. In terms of the relationship of the movable body with the facing member and the valve seat member, the direction in which the movable body moves in a direction toward and away from the facing member is not restricted by the facing member or the valve seat member, may be restricted by a member other than the facing member and the valve seat member, as long as the movable body is capable of moving toward and away from the valve seat member without moving toward and away from the facing member.

In addition, the shock absorber D of the present embodiment includes: a shock absorber main body A including a cylinder (cuter shell) 1, a piston rod 2 inserted into the cylinder (outer shell) 1 so as to re movable in the axial direction, and at least an extension side chamber (operation chamber) R1 and a compression side chamber (operation chamber) R2 between which liquid flows as the piston rod 2 moves with respect to the cylinder (outer shell) 1; and a damping valve V provided between the extension side chamber (operation chamber) R1 and the compression side chamber (operation chamber) R2. Since the shock absorber D configured in this manner includes a damping valve V capable of adjusting the damping force characteristic depending on the pressure upstream of the port, the damping force characteristic can be adjusted to suppress the vibration of the vehicle, thereby improving the ride comfort in the vehicle.

Although it is illustrated in FIG. 1 that the damping valve V is applied as an extension side damping valve of the shock absorber D, the damping valve V may be applied as a compression side damping valve. Although the extension side chamber R1 and the compression side chamber R2 are provided as two operation chambers, in a case where the shock absorber D is a double-cylinder shock absorber including an outer tube as an outer shell on the outer circumference of the cylinder and a reservoir between the cylinder and the outer tube, the damping valve V, V1, or V2 may be provided between the compression side chamber and the reservoir. Therefore, the port in the damping valve may allow communication between the extension side chamber R1 and the compression side chamber R2, or may allow communication between the compression side chamber and the reservoir.

Although the preferred embodiment of the present invention has been described in detail above, modifications, variations, and changes can be made without departing from the claims.

### REFERENCE SIGNS LIST

1 Cylinder
3 Piston (valve seat member)
3a Extension side port (port)
3c Extension side valve seat (valve seat)
9 Piston nut (facing member)
9b Fixed spring seat
9e Annular groove
10, 17 Movable body
10c Contact body facing portion
10d Relief portion
11 Coil spring (spring member)
12, 16 Contact body
14 Seal member
17c Recessed groove
17d Inclined surface
A Shock absorber main body
D Shock absorber
P Pilot passage
V, V1, V2 Damping valve

1. A damping valve comprising:
a valve seat member including a port and a valve seat surrounding an opening downstream of the port;
a movable body movable in a direction toward and away from the valve seat;
a facing member facing the movable body while being immovable with respect to the valve seat member;
a contact body provided to be displaceable toward the movable body with respect to the facing member to come into contact with the movable body; and
a pilot passage causing pressure upstream of the port to act on the contact body so as to press the contact body against the movable body.

2. The damping valve according to claim 1, wherein
the movable body is separated from and seated on the valve seat to open and close the port.

3. The damping valve according to claim 1, wherein
the movable body has an annular shape,
the facing member is disposed on an inner circumferential side of the movable body and has an annular groove on an outer circumference thereof, and
the contact body is an annular elastic body placed in the annular groove.

4. The damping valve according to claim 1, wherein
the movable body has an annular shape,
the facing member is disposed on an inner circumferential side of the movable body,
the damping valve further comprises:
a fixed spring seat provided on the facing member; and
a spring member interposed between the movable body and the fixed spring seat,
one end of the spring member is aligned in a radial direction by the facing member, and
the movable body has an inner diameter larger than an outer diameter of the facing member in a movement range of the movable body, and is aligned in the radial direction by the other end of the spring member.

5. The damping valve according to claim 1, wherein
the contact body is formed of a friction member that generates a frictional force between the movable body and the contact body when the contact body comes into contact with the movable body.

6. The damping valve according to claim 1, wherein
the movable body includes:
a recessed groove allowing the contact body to be inserted in a surface facing the facing member; and
an inclined surface provided adjacent to a valve seat member side of the recessed groove on a surface facing the facing member and abuttable against the contact body, and approaching the facing member as being farther away from the recessed groove toward the valve seat member, and
the damping valve further comprises a spring that biases the contact body toward the movable body.

7. The damping valve according to claim 2, wherein
the movable body has an annular shape,
the facing member is disposed on an inner circumferential side of the movable body, and
the damping valve further comprises an annular seal member having an inner circumferential side placed on an outer circumference of the facing member and an outer circumference abutting against the movable body.

8. The damping valve according to claim 3, wherein
the pilot passage causes the pressure upstream of the port to act on an inner circumference in a radial direction of the contact body.

9. The damping valve according to claim 5, wherein
the movable body includes
a relief portion located adjacent to a valve seat member side of a contact body on a surface facing the facing member, while not being in contact with the contact body, the contact body facing portion facing the contact body when the movable body is closest to the valve seat member.

10. A shock absorber comprising:
a shock absorber main body including an outer shell and a piston rod inserted into the outer shell so as to be movable in an axial direction so that at least two operation chambers are provided inside the outer shell; and
the damping valve according to claim 1 provided between the operation chambers.

11. A shock absorber comprising:
a shock absorber main body including an outer shell and a piston rod inserted into the outer shell so as to be movable in an axial direction so that at least two operation chambers are provided inside the outer shell; and
the damping valve according to claim 2 provided between the operation chambers.

12. A shock absorber comprising:
a shock absorber main body including an outer shell and a piston rod inserted into the outer shell so as to be movable in an axial direction so that at least two operation chambers are provided inside the outer shell; and
the damping valve according to claim 3 provided between the operation chambers.

13. A shock absorber comprising:
a shock absorber main body including an outer shell and a piston rod inserted into the outer shell so as to be movable in an axial direction so that at least two operation chambers are provided inside the outer shell; and
the damping valve according to claim 4 provided between the operation chambers.

14. A shock absorber comprising:
a shock absorber main body including an outer shell and a piston rod inserted into the outer shell so as to be movable in an axial direction so that at least two operation chambers are provided inside the outer shell; and
the damping valve according to claim 5 provided between the operation chambers.

15. A shock absorber comprising:
a shock absorber main body including an outer shell and a piston rod inserted into the outer shell so as to be movable in an axial direction so that at least two operation chambers are provided inside the outer shell; and
the damping valve according to claim 6 provided between the operation chambers.

16. A shock absorber comprising:
a shock absorber main body including an outer shell and a piston rod inserted into the outer shell so as to be movable in an axial direction so that at least two operation chambers are provided inside the outer shell; and
the damping valve according to claim 7 provided between the operation chambers.

17. A shock absorber comprising:
a shock absorber main body including an outer shell and a piston rod inserted into the outer shell so as to be movable in an axial direction so that at least two operation chambers are provided inside the outer shell; and
the damping valve according to claim 8 provided between the operation chambers.

18. A shock absorber comprising:
a shock absorber main body including an outer shell and a piston rod inserted into the outer shell so as to be movable in an axial direction so that at least two operation chambers are provided inside the outer shell; and
the damping valve according to claim 9 provided between the operation chambers.
